(19) United States
(12) Patent Application Publication
(10) Pub. No.: US 2005/0229204 A1
(43) Pub. Date: Oct. 13, 2005

(54) Signal processing method and arragement

(75) Inventor: Antonius Adrianus Cornelis Maria Kalker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/514,285

(22) PCT Filed: Apr. 22, 2003
(86) PCT No.: PCT/IB03/01879

§ 371 Date: Nov. 12, 2004

(30) Foreign Application Priority Data
May 16, 2002 (EP) 020769097

(51) Int. Cl. H04N 7/16; H04N 7/167; G06K 9/00

(52) U.S. Cl. 725/19; 725/18; 382/124; 380/210

(57) ABSTRACT

Disclosed is a method of processing an information signal. The method comprises the steps of determining (302) a fingerprint of the information signal; obtaining (308) at least a first property value of a predetermined first property of the information signal, the at least first property value being stored in relation to a first one of a plurality of stored fingerprints, the first property value corresponding to the determined fingerprint; and controlling (313), at least in part, processing of the information signal responsive to the obtained at least first property value, the processing resulting in a processed information signal.

This invention relates to the processing of an information signal and, more particular the separation of audio tracks.

When processing an information signal the type of processing, e.g. the choice of certain processing parameters may depend on the content of the information signal.

For example, when recording the tracks from a vinyl record to another recordable medium, e.g. a recordable CD, it is a difficult problem to separate the different audio tracks on the record.

A user may manually separate the tracks at recording time, i.e. the user supervises the recording, e.g. by listening to the audio tracks during recording and by operating the recording device accordingly. However, this has the disadvantage of requiring significant user interaction.

Furthermore it is known how to separate tracks by automatic silence detection. For example, a predetermined time period may be pre-selected and, if a period of silence is detected during the recording which is longer than the pre-selected period, the recording of a current track is terminated. However, these methods are error prone, as they may lead to the accidental merging of songs, e.g. if the pause between two songs is shorter than the predetermined time period, or the accidental separation of single songs, e.g. if there is a short period of relative silence within a song or a piece of classical music.

Furthermore, an entire sequence of tracks may be recorded as a single digital recording, e.g. a single wave file. Subsequently the audio tracks may be separated on a computing platform using an audio processing program. However, this is a cumbersome method, requiring multiple steps and user interaction. Hence, none of the above prior art methods are near to optimal for the end user.

Hence, it is a general object of the invention to provide an efficient processing of an information signal.

The above and other problems are solved by a method of processing an information signal, the method comprising the steps of
determining a fingerprint of the information signal;
obtaining at least a first property value of a predetermined first property of the information signal, the at least first property value being stored in relation to a first one of a plurality of stored fingerprints, the first property value corresponding to the determined fingerprint; and
controlling, at least in part, processing of the information signal responsive to the obtained at least first property value, the processing resulting in a processed information signal.

Consequently, the processing of the information signal is controlled on the basis of one or more properties of the content of the information signal where the corresponding property values are retrieved on the basis of a calculated fingerprint of the information signal. Hence, an efficient, reliable and user-friendly method of processing the information signal is achieved.

It is an advantage of the invention that the processing may be adapted to the content of the information signal, thereby improving the performance of the processing and/or the quality of the result of the processing.

The term information signal comprises any analogue or digital signal representing information content such as perceptual features, e.g. audible features and/or visual features, e.g. sound, music, speech, images, movies, animations, etc. Examples of such information signals include an audio signal, a video signal, an audio-visual signal, a multimedia signal, a multimedia object, etc.

A fingerprint of an information signal is a representation of the information signal in question. Preferably, the fingerprint is shorter than the information signal. Furthermore, preferably, the fingerprint represents the most relevant perceptual features of the signal in question. Such fingerprints are sometimes also known as “(robust) hashes”. The term robust hashes refers to a hash function which, to a certain extent, is robust with respect to data processing and signal degradation, e.g. due to compression/decompression, coding, AD/DA conversion, etc. Robust hashes are sometimes also referred to as robust summaries, robust signatures, or perceptual hashes.

In a system using fingerprinting technology, the fingerprints of a large number of information signals along with their associated respective data are stored, e.g. in a database. The associated data may comprise metadata where the term “metadata” refers to information about the content of the information signal such as the title, artist, genre and so on. According to the invention the associated data comprises at least a first property value of a first property for use in the processing of the information signal. The associated data is retrieved by computing a fingerprint of the information signal and by performing a lookup or query in the database using the computed fingerprint as a lookup key or query parameter. The lookup then returns the data associated with the fingerprint.

There are several advantages in storing fingerprints for information signals in a database instead of the information signal or its content itself. To name a few:
The memory/storage requirements for the database are reduced.
The comparison of fingerprints is more efficient than the comparison of the information signals themselves, as fingerprints are substantially shorter than the signals.
Searching in a database for a matching fingerprint is more efficient than searching for a complete information signal, since it involves matching shorter items.
Searching for a matching fingerprint is more likely to be successful, as small changes to an information signal (such as encoding in a different format or changing the bit rate) do not affect the fingerprint.

An example of a method of generating a fingerprint is described in European patent application number 01200505.4 (attorney docket PHNL001110) as well as in Jaap Haitsma, Ton Kalker and Job Oostveen, “Robust Audio Hashing For Content Identification”, International Workshop on Content-Based Multimedia Indexing, Brescia, September 2001.

The at least first property may be any property relevant for a subsequent processing of the information signal, e.g. continuous valued properties, such as time, continuous parameter settings, etc, or category data, such as type of content, genre, etc. Examples of such properties comprise, the duration of the content or a predetermined part of the content of an information signal, e.g. the length of an audio track recorded as part of a sequence of audio tracks, the music genre, of an audio content, the movie genre of a movie content, parameter values for a subsequent processing, e.g. equalizer settings, parameters for use of an encoding scheme, etc.

The fingerprint data and the associated property data may be stored locally in the same device performing the processing of the signal, e.g. on a storage-medium of the processing device, on a storage medium connected to the device, e.g. on a data carrier inserted in a corresponding reader, e.g. a CD, or the like. It is an advantage of locally storing the fingerprint data, that no connection to a remote database is necessary.

Alternatively or additionally, the fingerprint data may be stored at a remote location, e.g. in a remote fingerprint database of a data processing system, e.g. a server computer. For example, the remote fingerprint database may be accessible via a communications network, such as the Internet, a cable television network, or any other suitable data connection, such as a wired or a wireless connection, a permanent connection, or a temporary connection, such as a dial-up connection, etc. It is an advantage of retrieving the property values from a remote fingerprint data that the processing device does not need to perform and database querying, fingerprint matching, etc., thereby keeping the processing device simple. Furthermore, fingerprint data may be stored as a combination of locally stored data and a remote database. For example, if a fingerprint cannot be identified in a local database, a query may be forwarded to a remote database comprising a larger number of fingerprints.

Hence, according to a preferred embodiment of the invention, the step of obtaining the at least first property value comprises the steps of transmitting the determined fingerprint to a fingerprint server having access to a database of stored fingerprints and being adapted to retrieve said at least first property value associated with a corresponding one of the stored fingerprints; and receiving the retrieved at least first property value from said fingerprint server.

The processing of the information signal may comprise any type of signal processing, e.g. processing of an analogue signal or digital signal. Examples of such signal processing include extracting one or more segments from an information signal, merging information signals, encoding and/or decoding a signal, reproducing the signal, e.g. by a player device, a data processing system, a television, or the like. The processing may be controlled in total or in part on the basis of the identified property value.

In a preferred embodiment of the invention, the information signal is an audio signal representing at least a first audio track followed by a second audio track, the first audio track having a predetermined length, wherein the first property is the length of the first audio track, and wherein the step of controlling processing the information signal comprises the step of separating the first audio track from the second audio track.

Consequently, an accurate, reliable, and user-friendly separation of audio tracks is provided.

In a further preferred embodiment of the invention, the step of obtaining at least a first property value of a predetermined first property of the information signal further comprises the step of obtaining a second property value indicative of a time location within the first audio track, and wherein the step of separating the first audio track from the second audio track comprises the step of determining a remaining duration of the first audio track from the obtained length of the first audio track and the obtained time location within the first audio track.

Consequently, the information used for an accurate separation of audio tracks is reliably retrieved, even under conditions of degradation, such as wow and flutter, ticks, speed changes, for example when recording from a radio station. Based on the time location, i.e. how far the recording has proceeded in the track, and the length of the track, the track separation can be done accurately, e.g. by calculating the remaining track time or by comparing the tracks to be recorded to reference tracks, e.g. the original tracks.

In another preferred embodiment of the invention, the information signal comprises an audio signal representing music of a predetermined music genre, wherein the at least first property value is indicative of the music genre, and wherein the step of controlling processing the information signal comprises the step of adjusting gain settings for different frequency bands of the information signal.

Many music players, e.g. home HiFi devices, software players, etc., are equipped with equalizers, allowing to set different gains for different frequency bands. Typically equalizer settings are different for different musical genres. For example, pop music is usually played with boosted low and high frequencies, whereas classical music is preferred with a more level setting. It is an advantage of the invention that these types of equalizer settings can be determined automatically, by connecting to a remote fingerprint database, or using a locally stored fingerprint database.

In yet another preferred embodiment of the invention, the information signal comprises an audio-visual signal representing a video program of a predetermined content, wherein the at least first property value is indicative of said content, and wherein the step of controlling processing the information signal comprises the step of adapting predetermined display characteristics of a display device for displaying the video program.

Modern television sets have the option to set certain display characteristics. For example, nature movies are better viewed with settings that allow good reproduction of natural colors, whereas cartoons are better viewed with improved sharpness. It is an advantage of the invention that video identification through video fingerprinting allows automatic adaptation of these settings according to the content that is being watched.

In yet another preferred embodiment of the invention, the information signal comprises a video signal, wherein the at least first property value is indicative of a set of coding parameters of a video encoding scheme, and wherein the step of controlling processing the information signal comprises the step of encoding the video signal using the obtained coding parameters. Consequently, when encoding a video program, e.g. prior to storing a video program, relevant coding parameters, e.g. scene changes, motion information, etc., may be retrieved and used in the control of the encoding process, thereby improving the video encoding, e.g. achieving a better compression rate and/or reducing the losses in quality due to the coding.

In still another preferred embodiment of the invention, the step of determining a fingerprint of the information signal comprises the step of determining a fingerprint of at least one segment of the information signal, and wherein the plurality of stored fingerprints comprise fingerprints of at least predetermined segments of predetermined information signals. Consequently, a fingerprint is determined for one or more parts of an information signal only, thereby reducing the required computational resources for calculating the fingerprint and for matching the fingerprint with stored fingerprints.

For example, in the case of audio signals, a fingerprint does not need to be calculated for an entire audio track of several minutes. In some embodiments it may be sufficient to calculate fingerprints of short segments of the audio tracks, e.g. a short segment at the beginning, near the middle, and near the end of the track.

Preferably, according to this embodiment, fingerprint data for at least the most characteristic segments of an information signal is made available in a database or the like. For example, in the case of audio signals, fingerprints for short segments or clips may be stored, which may be identified wit a time accuracy of down to 0.1 sec.

The present invention can be implemented in different ways including the method described above and in the following, an arrangement, and further product means, each yielding one or more of the benefits and advantages described in connection with the first-mentioned method, and each having one or more preferred embodiments corresponding to the preferred embodiments described in connection with the first-mentioned method and disclosed in the dependant claims.

It is noted that the features of the method described above and in the following may be implemented in software and carried out in a data processing system or other processing means caused by the execution of computer-executable instructions. The instructions may be program code means loaded in a memory, such as a RAM, from a storage medium or from another computer via a computer network. Alternatively, the described features may be implemented by hardwired circuitry instead of software or in combination with software.

The invention further relates to an arrangement for processing an information signal, the arrangement comprising
processing means adapted to determine a fingerprint of the information signal, and to obtain at least a first property value of a predetermined first property of the information signal, the at least first property value being stored in relation to a corresponding one of a plurality of stored fingerprints; and
control means adapted to control, at least in part, processing the information signal responsive to the obtained at least first property value, the processing resulting in a processed information signal.

The above arrangement may be part of any electronic equipment including recording devices for recording of audio signals, video signals or the like, e.g. Hifi equipment, video recorders, etc. Other examples include devices for reproducing information content, such as video recorders, audio players, television sets, etc., and other devices for processing information signals, such as computers, e.g. stationary and portable PCs, stationary and portable radio communications equipment and other handheld or portable devices, such as mobile telephones, pagers, audio players, multimedia players, communicators, i.e. electronic organizers, smart phones, personal digital assistants (PDAs), handheld computers, or the like.

The term processing means comprises general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof. The term control means comprises circuitry suitably adapted to control processing of the information signal. For example, the control means may comprise processing means as described above.

The arrangement may further comprise storage means for storing the plurality of fingerprints. Here, the term storage means comprises magnetic tape, optical disc, digital video disk (DVD), compact disc (CD or CD-ROM), mini-disc, hard disk, floppy disk, ferro-electric memory, electrically erasable programmable read only memory (EEPROM), flash memory, EPROM, read only memory (ROM), static random access memory (SRAM, dynamic random access memory (DRAM), synchronous dynamic random access memory (SDRAM), ferromagnetic memory, optical storage, charge coupled devices, smart cards, PCMCIA card, etc. The term storage means further comprises input devices for reading a computer-readable medium. Examples of such receiving means include a floppy-disk drive, a CD-Rom drive, a DVD drive, or any other suitable disc drive, a memory card adapter, a smart card adapter, etc.

The invention further relates to a data structure adapted to store a plurality of fingerprints of a plurality of corresponding information signals, wherein the data structure is adapted to store each of the plurality of fingerprints in relation to at least a corresponding first property value of a predetermined first property of the corresponding information signal for controlling, at least in part, processing the information signal resulting in a processed information signal. The data structure may be embodied in a known database structure, e.g. as one or more tables in a relational database.

The invention further relates to a computer-readable medium comprising a plurality of stored fingerprints of a plurality of corresponding information signals, wherein each of the plurality of stored fingerprints is stored in relation to at least a corresponding first property value of a predetermined first property of the corresponding information signal for controlling, at least in part, processing the information signal resulting in a processed information signal.

The term computer-readable medium comprises magnetic tape, optical disc, digital video disk (DVD), compact disc (CD or CD-ROM), mini-disc, hard disk, floppy disk, ferro-electric memory, electrically erasable programmable read only memory (EEPROM), flash memory, EPROM, read only memory (ROM), static random access memory (SRAM), dynamic random access memory (DRAM), synchronous dynamic random access memory (SDRAM), ferromagnetic memory, optical storage, charge coupled devices, smart cards, PCMCIA card, etc.

The invention further relates to an information signal generated by a method of processing a source information signal as described above and in the following.

The invention further relates to a computer program product arranged for causing a processor to execute the method described above and in the following.

The computer program product may be embodied on a computer-readable medium. The term computer-readable medium may include magnetic tape, optical disc, digital video disk (DVD), compact disc (CD or CD-ROM), mini-disc, hard disk, floppy disk, ferro-electric memory, electrically erasable programmable read only memory (EEPROM), flash memory, EPROM, read only memory (ROM), static random access memory (SRAM), dynamic random access memory (DRAM), synchronous dynamic random access memory (SDRAM), ferromagnetic memory, optical storage, charge coupled devices, smart cards, PCMCIA card, etc.

These and other aspects of the invention will be apparent from and elucidated with reference to the embodiments and with reference to the drawing, in which:

FIG. 1 schematically shows a system for recording audio tracks according to an embodiment of the invention with a remote fingerprint database;

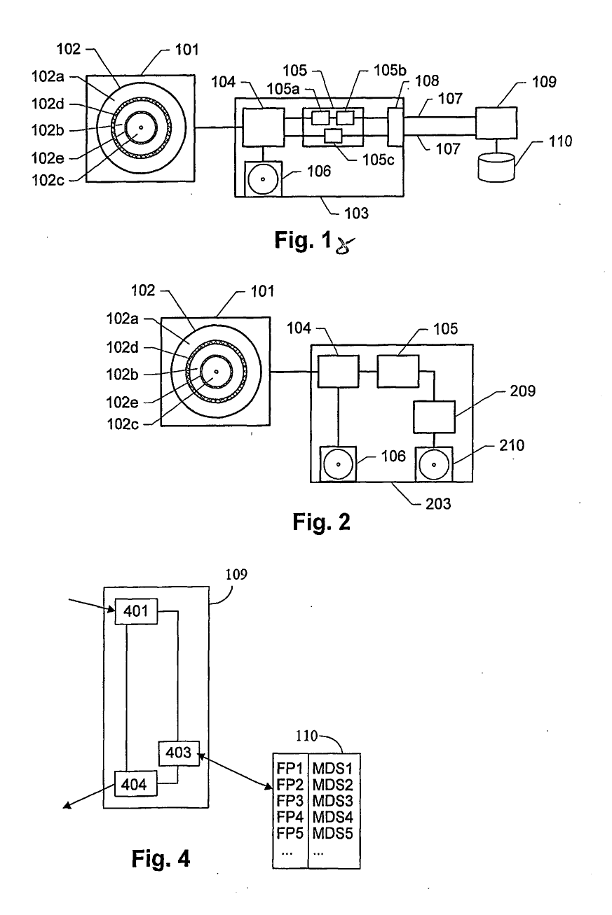

FIG. 2 schematically shows a system for recording audio tracks according to an embodiment of the invention with a local fingerprint database;

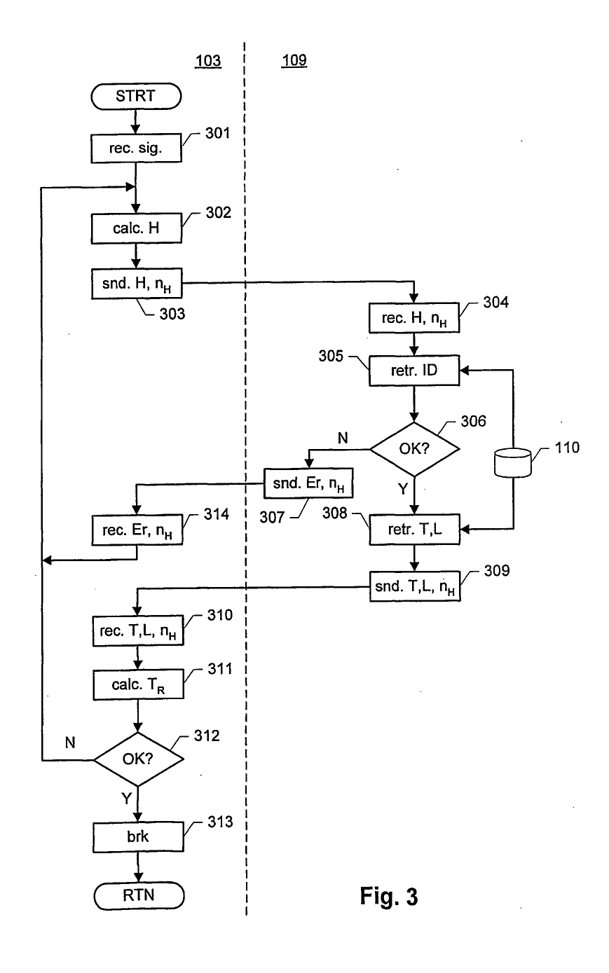

FIG. 3 shows a flow diagram of a method of separating audio tracks according to an embodiment of the invention;

FIG. 4 schematically shows the server 109 and the fingerprint database 110 in more detail;

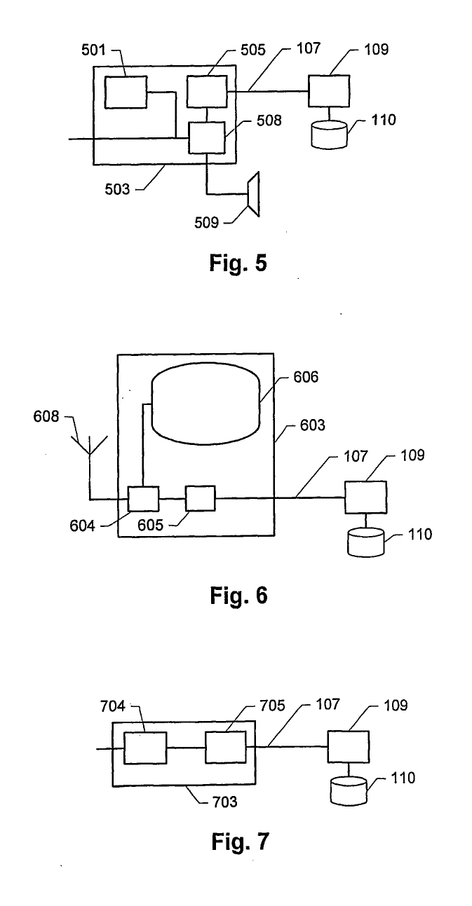

FIG. 5 schematically shows a music player using fingerprint data to determined equalizer settings according to an embodiment of the invention;

FIG. 6 schematically shows a television set using fingerprint data to set display characteristics according to an embodiment of the invention; and

FIG. 7 schematically shows a video recorder using fingerprint data to determine coding parameters of an encoding scheme according to an embodiment of the invention.

FIG. 1 schematically shows a system for recording audio tracks according to an embodiment of the invention with a remote fingerprint database. The system comprises an audio source 101, a recorder 103 and a fingerprint server 109 having access to a fingerprint database 110.

In the example of FIG. 1, the audio source is a record player for playing a vinyl record 102 comprising audio tracks such as music, speech, etc. The record player 101 outputs an analogue audio signal which may be fed into an amplifier or a recorder 103 for recording the audio program on a different carrier. Alternatively, other audio sources may be used, e.g. a radio for receiving radio programs over the air or a cable network, tape recorders, or the like.

On a conventional vinyl record, a number of audio tracks may be recorded separated by intervals of relative silence. However, due to the periods of relative silence, there may still be a certain level of audible noise, e.g. due to imperfections of the vinyl record or the player, damages such as scratches, dust, etc. In the example of FIG. 1, the vinyl record 102 is illustrated with tracks 102a-c separated by intervals 102d-e. The audio signal generated from the audio source 101 is fed into the recorder 103, e.g. via a conventional line inputjack.

The recorder 103 comprises a CD drive 106 for recording audio tracks on a CD and corresponding circuitry 104 for controlling the recording of an incoming audio signal. The circuitry 104 may further perform conventional signal processing, such as AD conversion, filtering, compression (e.g. MP3) etc.

According to the invention, the recorder 103 further comprises circuitry 105 for track separation. The circuitry 105 receives the audio signal from circuitry 104 and comprises circuitry for calculating a fingerprint from the audio signal. The circuitry 105 here comprises an input module 105a, a fingerprinting module 105b, and a track separation control module 105c. The input module 105a receives an audio clip from circuitry 104 and feeds the audio clip to the fingerprinting module 105b. The fingerprinting module 105b computes a fingerprint from the received audio clip. One method for computing a robust fingerprint is described in European patent application 01200505.4 (attorney docket PHNL010110), although of course any method for computing a robust fingerprint can be used.

European patent application 01200505.4 (attorney docket PHNL010110) describes a method that generates robust fingerprints for multimedia objects such as, for example, audio clips. The audio clip is divided in successive (preferably overlapping) time intervals. For each time interval, the frequency spectrum is divided in bands. A robust property of each band (e.g. energy) is computed and represented by a respective fingerprint bit.

A multimedia object is thus represented by a fingerprint comprising a concatenation of binary values, one for each time interval. The fingerprint does not need to be computed over the whole multimedia object, but can be computed when a portion of a certain length, typically about three seconds, has been received. There can thus be plural fingerprints for one multimedia object, depending on which portion is used to compute the fingerprint over. For reasons of clarity, the term “the fingerprint” will be used even in cases when multiple fingerprints for one multimedia object can exist.

The recorder 103 further comprises communication circuitry 108 which receives the computed fingerprint from circuitry 105 and transmits the calculated fingerprint data to a fingerprint server 109 via a communications link 107. The communications circuitry 108 further comprises circuitry for receiving a response from the fingerprint server indicating the length of the current audio track and information about a current position within the current audio track corresponding to the calculated fingerprint. The received data is fed back to the track separation control module 105c of circuit 105. The track separation control module 105c is adapted to calculate a remaining song time on the basis of the received information and to generate a control signal indicative of the remaining song time which is fed into the circuit 104. The circuit 104 then uses this information to identify the end of the current track.

The fingerprint server 109 may be a suitably programmed server computer having access to a database 110. The fingerprint server 109 receives a request from the recorder 103 including a calculated fingerprint. In response to this request, the fingerprint server identifies the fingerprint in the database 110 and returns the requested data associated with the stored fingerprint, e.g. as described in connection with FIGS. 3-4.

The communications link 107 may be any suitable wired or wireless data link, for example a packet-based communications network, such as the Internet or another TCP/IP network, a short-range communications link, such as a radio-based link, or the like. Further examples of the communications channel include computer networks and wireless telecommunications networks, such as a Cellular Digital Packet Data (CDPD) network, a Global System for Mobile (GSM) network, a Code Division Multiple Access (CDMA) network, a Time Division Multiple Access Network (TDMA), a General Packet Radio service (GPRS) network, a Third Generation network, such as a UMTS network, or the like.

Accordingly, the communications circuit 108 comprises circuitry and/or devices suitable for enabling the communication of data via the communications link 107. Examples of such circuitry include a network interface, a network card, a radio receiver, a receiver for other suitable electromagnetic signals, or the like. Further examples of such circuitries include a cable modem, a telephone modem, an Integrated Services Digital Network (ISDN) adapter, a Digital Subscriber Line (DSL) adapter, a satellite transceiver, an Ethernet adapter, or the like.

It is noted that, alternatively to computing the fingerprint in the recorder, short audio clips may be transmitted to the server 109. In this alternative embodiment the server 109 comprises circuitry for calculating a fingerprint of the received audio clip, thereby reducing the required computational resources at the recorder at the cost of increased bandwidth requirements.

FIG. 2 schematically shows a system for recording audio tracks according to an embodiment of the invention with a local fingerprint database. The system comprises an audio source 101 and a recorder 203, e.g. a multi-disk recorder. According to this embodiment the fingerprint data is stored locally in the recorder 203. In the example of FIG. 2, the recorder 203 comprises a second CD drive 210 in which a CD having stored thereon a fingerprint database may removably be inserted. The recorder further comprises circuitry 209 for controlling access to the data stored on the CD and for performing fingerprint matching etc., i.e. the circuitry 209 performs a function corresponding to the fingerprint server 109 in the embodiment of FIG. 1, e.g. as described in connection with FIGS. 3-4. Hence, according to this embodiment, the recorder does not need to comprise circuitry for communicating with a remote database, thereby providing a self-contained recording system including track separation.

It is understood that, alternatively to storing the fingerprint data on a CD, other storage media may be used, such as a DVD, a hard disk drive, memory cards, EPROM, EEPROM, etc.

It is further understood that the track separation according to FIG. 1 or 2 may also be performed in a separate device receiving input from the audio source 101 and generating an output that corresponds to a single audio track which may be fed into a recorder. This has the advantage that a conventional recorder may be used, such as the CD recorder CDR-800 manufactured by Philips. For example, the device for separating the tracks may be a suitably programmed computer having access to the fingerprint database, e.g. on a CD or the like, via the Internet, etc.

It is further understood that the recorders in FIGS. 1 or 2 may be adapted to record the separated audio tracks on a recordable medium other than a CD, for example on a DVD, or as files on a data storage medium, such as a hard disk, a diskette, or any other computer-readable medium.

FIG. 3 shows a flow diagram of a method of separating audio tracks according to an embodiment of the invention.

In an initial step a recording device 103 receives an analogue input signal. For example, the input signal may be received from a record player playing a vinyl record or from another audio source, as described in connection with FIG. 1.

In step 302 a fingerprint H is calculated for a segment of the received audio signal.

In step 303, the calculated fingerprint is sent to a fingerprint server 109 together with an identifier n_{H} which identifies the fingerprint H.

The fingerprint server 109 receives the calculated fingerprint H and the identifier n_{H} in step 304.

In step 305 the server retrieves a song ID from a database 110 using the fingerprint H as a key. If no matching song ID was found, the server may return to step 304 waiting for a new request.

Optionally, in step 307, the server may return a message indicating the failure of identifying a song ID. Upon receipt of this message in step 314, the recorder may return to step 302, calculating a new fingerprint for another segment of the input audio signal.

In step 308, if a valid song ID was retrieved from the database in step 305, the corresponding time location T of the fingerprint H from the start of the identified song is retrieved from the database 110 as well as the total length of the identified song.

In step 309, the retrieved time location T and the total length L are returned to the recorder 103 together with the fingerprint identifier n_{H}.

In step 310, the recorder receives the returned data and, in step 311, the recorder calculates the remaining song time T_{R}=L−T−T_{req}, where T_{req} is the delay introduced from the calculation of the fingerprint until the calculation of the remaining time. For example, this delay may be measured by the recorder by starting a timer, e.g. during step 302 above. Thus, the elapsed time may be determined at step 311 and used in the calculation of T_{R}.

Based on the remaining song time T_{R}, the end of the current track may be determined in step 312. If the end of the track is reached, the recording of the current track is terminated in step 313. Otherwise, the recorder returns to step 302 and calculates a new fingerprint for another section. Alternatively or additionally, a timer may be started, thereby allowing the recorder to determine when the time T_{R} has elapsed and enabling the recorder to estimate the end of the current track, even without calculating further fingerprints.

FIG. 4 schematically shows the server 109 and the fingerprint database 110 in more detail. The server 109 here comprises an input module 401, a Database Management System (DBMS) backend module 403, and a response module 404.

The input module 401 receives a fingerprint from a client device and supplies the fingerprint to the DBMS backend module 403. The DBMS backend module 303 performs a query on the database 110 to retrieve a set of metadata associated with the computed fingerprint from the database 110. As shown in FIG. 4, the database 110 comprises fingerprints FP1, FP2, FP3, FP4 and FP5 and respective associated sets of metadata MDS1, MDS2, MDS3, MDS4 and MDS5. The above-mentioned European patent application 01200505.4 (attorney docket PHNL010110) describes various matching strategies for matching fingerprints computed for an audio clip with fingerprints stored in a database.

European patent application 01202720.7 (attorney docket PHNL010510) describes an efficient method of matching a fingerprint representing an unknown information signal with a plurality of fingerprints of identified information signals stored in a database to identify the unknown signal. This method uses reliability information of the extracted fingerprint bits. The fingerprint bits are determined by computing features of an information signal and thresholding said features to obtain the fingerprint bits. If a feature has a value very close to the threshold, a small change in the signal may lead to a fingerprint bit with opposite value. The absolute value of the difference between feature value and threshold is used to mark each fingerprint bit as reliable or unreliable. The reliabilities are subsequently used to improve the actual matching procedure.

The database 110 can be organized in various ways to optimize query time and/or data organization. The output from the input module 401 should be taken into account when designing the tables in the database 110. In the embodiment shown in FIG. 4, the database 110 comprises a single table with entries (records) comprising respective fingerprints and sets of metadata. The DBMS backend module 403 feeds the results of the query to the response module 404, which transmits the results to the client device.

FIG. 5 schematically shows a music player using fingerprint data to determine equalizer settings according to an embodiment of the invention. Many music players are equipped with equalizers, allowing to set different gains for different frequency bands. Typically equalizer settings are different for different musical genres. For example, pop music is usually played with boosted low and high frequencies, whereas classical music is preferred with a more level setting. Using music identification through fingerprinting these types of equalizer settings can be determined automatically, either through connecting with a remote fingerprint database (for connected players), or using a locally stored fingerprint database.

In the example of FIG. 5, a music player 503, e.g. a home HiFi device, a software player, or the like, comprises an equalizer 508 which receives an audio signal as an input, e.g. an external signal, e.g. from another audio source, such as a record player, tape recorder, etc., or a signal from a sound source 501 included in the music player, e.g. a CD player, radio tuner, tape recorder, record player, etc. The equalizer 508 controls the gain of the output signal that may be fed into a speaker 509, another amplifier (not shown), or the like. The input audio signal is further fed into a fingerprint module 505 which computes fingerprints of received audio clips as described in connection with FIG. 1. The fingerprint module sends the calculated fingerprint to a database server 109 which queries a database 110 and returns genre information, e.g. an identifier code identifying one of a number of genres, to the fingerprint module. The fingerprint module uses the genre information to control the equalizer settings of the equalizer 508.

FIG. 6 schematically shows a television set 603 using fingerprint data to set display characteristics according to an embodiment of the invention.

Modern television sets have the option to set certain display characteristics. For example, nature movies are better viewed with settings that allow good reproduction of natural colors, whereas cartoons are better viewed with improved sharpness. Again, video identification through video fingerprinting allows automatic adaptation of these settings according to the content that is being watched.

The television set 603 receives a television signal via an aerial 608. Alternatively or additionally, the television set 603 may receive a television signal via other channels, e.g. a cable network, satellite, etc. The television set comprises a control circuit 604 for controlling the display 606 of the television set, including controlling the display characteristics. According to the invention, the television set 603 further comprises a fingerprint module 605 that receives the video signal from control circuit 604 and computes a corresponding fingerprint. The fingerprint module 605 sends the calculated fingerprint to a fingerprint server 109 that returns metadata associated to the computed fingerprint, as described above. The returned metadata is fed back into the fingerprint module 605 that causes the control circuit 604 to set appropriate display settings.

FIG. 7 schematically shows a video recorder 703 using fingerprint data to determine coding parameters of an encoding scheme according to an embodiment of the invention.

Modern video recorders, for example digital set-top boxes or so-called personal television recorders or servers allow a user to record television programs directly to a hard disk. Examples of such personal video recorders include the Tivo recorder and the Replay recorder manufactured by Philips. Such recorders make use of modern video compression standards, such as MPEG-2 or the like, to store recorded video programs.

In the example of FIG. 7, the video recorder 703 comprises an encoding module 704 for encoding a video signal. Video encoding is usually much more complex than video decoding: video encoding entails the search over a large space of free parameters to obtain the best trade-off between rate (number of bytes to be used) and the video quality. Video decoding engines do not suffer from this complexity, as their only task is to interpret the chosen parameters. In general, high quality video encoding requires many more computing resources than are available within a relatively inexpensive consumer device.

According to this embodiment, the video recorder further comprises a fingerprint module 705 that assists the video encoding module 704 in the choice of the free parameters, thereby improving the overall encoding quality. These parameters may be pre-computed for a given movie or video program, and stored as meta-data with computed video fingerprint data on a database 110. For a given video signal to be encoded by the encoder 704, the video signal is fed into the fingerprint module 705 that computes a fingerprint of the video signal or a part of the video signal.

The fingerprint module sends the computed fingerprint to a fingerprint server 109 that retrieves relevant coding parameters such as scene changes, motion information, etc., for improved video encoding. For example the video recorder may connect to the fingerprint server via the Internet, a cable television network, or the like. The received coding parameters are fed back into the encoding module 704 that performs the video encoding accordingly.

It is understood that a skilled person may adapt the above embodiments, e.g. by adding or removing features, or by combining features of the above embodiments. For example, it is understood that in all the above embodiments, the fingerprint database may be a local or a remote database, or a combination thereof. Furthermore, the retrieval of property values for controlling signal processing based on a calculated fingerprint may be combined with retrieval of other data for other purposes, e.g. the retrieval of metadata to be presented to a user.

It is noted that the above arrangements may be implemented as general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

It is further noted that the invention has been described in connection with a number of embodiments. However, it is understood, that a skilled person will be able to apply the present invention to other forms of signal processing, thereby using knowledge of the identity of a particular audio-visual item or other information item to improve associated signal processing.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of processing an information signal, the method comprising the steps of
determining a fingerprint of the information signal;
obtaining at least a first property value of a predetermined first property of the information signal, the at least first property value being stored in relation to a first one of a plurality of stored fingerprints, the first property value corresponding to the determined fingerprint; and
controlling, at least in part, processing of the information signal responsive to the obtained at least first property value, the processing resulting in a processed information signal.

2. A method according to claim 1, wherein the information signal is an audio signal representing at least a first audio track followed by a second audio track, the first audio track having a predetermined length, wherein the first property is the length of the first audio track, and wherein the step of controlling processing the information signal comprises the step of separating the first audio track from the second audio track.

3. A method according to claim 2, wherein the step of obtaining at least a first property value of a predetermined first property of the information signal further comprises the step of obtaining a second property value indicative of a time location within the first audio track, and wherein the step of separating the first audio track from the second audio track comprises the step of determining a remaining duration of the first audio track from the obtained length of the first audio track and the obtained time location within the first audio track.

4. A method. according to claim 1, wherein the information signal comprises an audio signal representing music of a predetermined music genre, wherein the at least first property value is indicative of the music genre, and wherein the step of controlling processing the information signal comprises the step of adjusting gain settings for different frequency bands of the information signal.

5. A method according to claim 1, wherein the information signal comprises an audio-visual signal representing a video program of a predetermined content, wherein the at least first property value is indicative of said content, and wherein the step of controlling processing the information signal comprises the step of adapting predetermined display characteristics of a display device for displaying the video program.

6. A method according to claim 1, wherein the information signal comprises a video signal, wherein the at least first property value is indicative of a set of coding parameters of a video encoding scheme, and wherein the step of controlling processing the information signal comprises the step of encoding the video signal using the obtained coding parameters.

7. A method according to claim 1, wherein the information signal is selected from a group of information signals consisting of an audio signal, a video signal, a multimedia signal and an audio-visual signal.

8. A method according to claim 1, wherein the step of obtaining the at least first property value comprises the steps of transmitting the determined fingerprint to a fingerprint server having access to a database of stored fingerprints and being adapted to retrieve said at least first property value associated with a corresponding one of the stored fingerprints; and receiving the retrieved at least first property value from said fingerprint server.

9. A method according to claim 1, wherein the step of determining a fingerprint of the information signal comprises the step of determining a fingerprint of at least one segment of the information signal, and wherein the plurality of stored fingerprints comprise fingerprints of at least predetermined segments of predetermined information signals.

10. An arrangement for processing an information signal, the arrangement comprising
processing means adapted to determine a fingerprint of the information signal, and to obtain at least a first property value of a predetermined first property of the information signal, the at least first property value being stored in relation to a corresponding one of a plurality of stored fingerprints; and
control means adapted to control, at least in part, processing the information signal responsive to the obtained at least first property value, the processing resulting in a processed information signal.

11. An arrangement according to claim 10, further comprising storage means for storing the plurality of stored fingerprints.

12. A data structure adapted to store a plurality of fingerprints of a plurality of corresponding information signals, wherein the data structure is adapted to store each of the plurality of fingerprints in relation to at least a corresponding first property value of a predetermined first property of the corresponding information signal for controlling, at least in part, processing the information signal resulting in a processed information signal.

13. A computer-readable medium comprising a plurality of stored fingerprints of a plurality of corresponding information signals, wherein each of the plurality of stored fingerprints is stored in relation to at least a corresponding first property value of a predetermined first property of the corresponding information signal for controlling, at least in part, processing the information signal resulting in a processed information signal.

14. An information signal generated by a method of processing a source information signal, the method comprising the steps of
determining a fingerprint of the source information signal;
obtaining at least a first property value of a predetermined first property of the source information signal, the at least first property value being stored in relation to a first one of a plurality of stored fingerprints, the first property value corresponding to the determined fingerprint; and
controlling, at least in part, processing the source information signal responsive to the obtained at least first property value, the processing resulting in the information signal.

15. A computer program product arranged for causing a processor to execute the method of claim 1.
